(19) United States
(12) Patent Application Publication
(10) Pub. No.: US 2025/0100116 A1
(43) Pub. Date: Mar. 27, 2025

(54) SEAL REMOVAL TOOL

(71) Applicant: TIEN-I INDUSTRIAL CO., LTD., Taichung City (TW)

(72) Inventor: Larry LEE, Taichung City (TW)

(21) Appl. No.: 18/474,618

(22) Filed: Sep. 26, 2023

(51) Int. Cl. B25B 27/00

(52) U.S. Cl. CPC B25B 27/0028

(57) ABSTRACT

A seal removal tool is provided, wherein the seal removal tool includes: a handle; a working rod including a working head and a body portion connected to each other, the body portion having a non-circular cross-section, the body portion and the handle being connected to each other by insertion; and a positioning mechanism including at least one first positioning unit and at least one second positioning unit releasably connected to each other, the at least one first positioning unit being disposed on the handle, the at least one second positioning unit being disposed on the body portion.

### BACKGROUND OF THE INVENTION

### Field of the Invention

The present invention relates to a seal removal tool.

### Description of the Prior Art

There will inevitably be gaps between the components that are assembled together in the equipment. In order to improve the tightness and fitness between the components and prevent leakage, at least one seal is usually used to fill the gaps during assembly. The at least one seal is may be a gasket, O-ring or the like.

It is understandable that there will usually be situations where the seals need to be removed and replaced, for example, in replacing components, occurrence of leakage, regular safety inspection of components, replacement of seals, etc. Generally, most workers remove the seal directly with their hands, however, it is often encountered that the seal is installed deep inside the component or the environment is narrow, making it impossible for the worker's hands to reach it. As a result, it only allows to use non-specific tools possibly available to disassemble the seal, resulting in damage to the seal easily.

The present invention is, therefore, arisen to obviate or at least mitigate the above-mentioned disadvantages.

### SUMMARY OF THE INVENTION

The main object of the present invention is to provide a seal removal tool which can be used according to various requirements.

To achieve the above and other objects, a seal removal tool is provided, wherein the seal removal tool includes: a handle; a working rod including a working head and a body portion connected to each other, the body portion having a non-circular cross-section, the body portion and the handle being connected to each other by insertion; and a positioning mechanism including at least one first positioning unit and at least one second positioning unit releasably connected to each other, the at least one first positioning unit being disposed on the handle, the at least one second positioning unit being disposed on the body portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a partial enlarged drawing showing a body portion of an exemplary embodiment of the present invention;

FIG. 4 is a cross-sectional view taken along the line A-A of FIG. 1;

FIG. 5 is a front view of an exemplary embodiment of the present invention;

FIG. 6 is an enlargement of FIG. 5; and

FIG. 7 is a drawing showing a slidable sleeve moving to a release position according to an exemplary embodiment of the present invention.

### DETAILED DESCRIPTION OF THE PREFERRED EMBODIMENTS

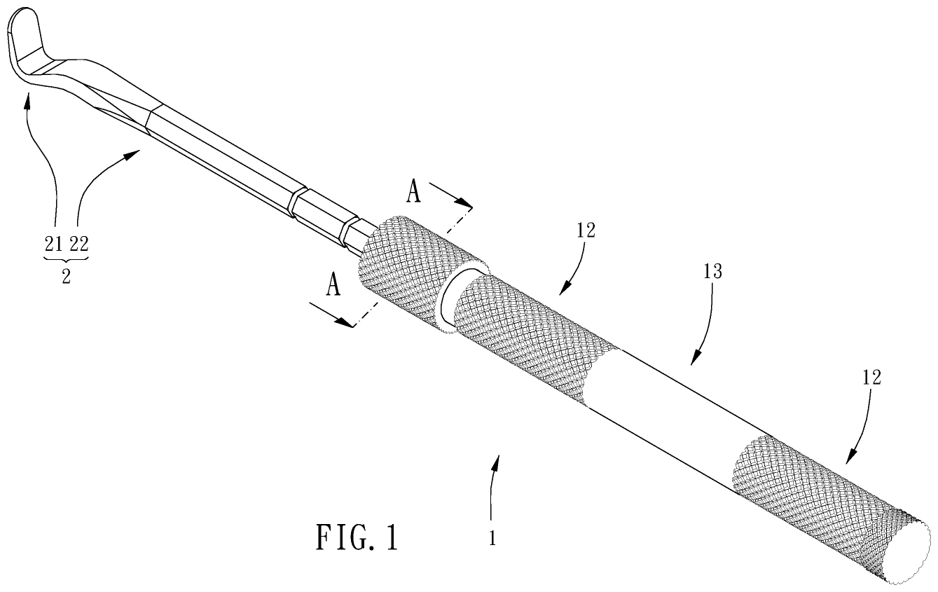

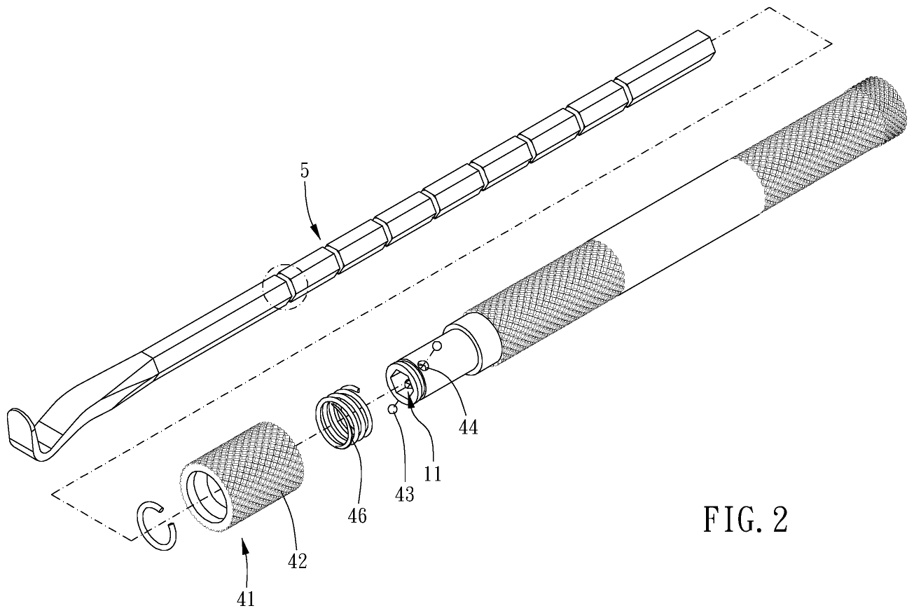

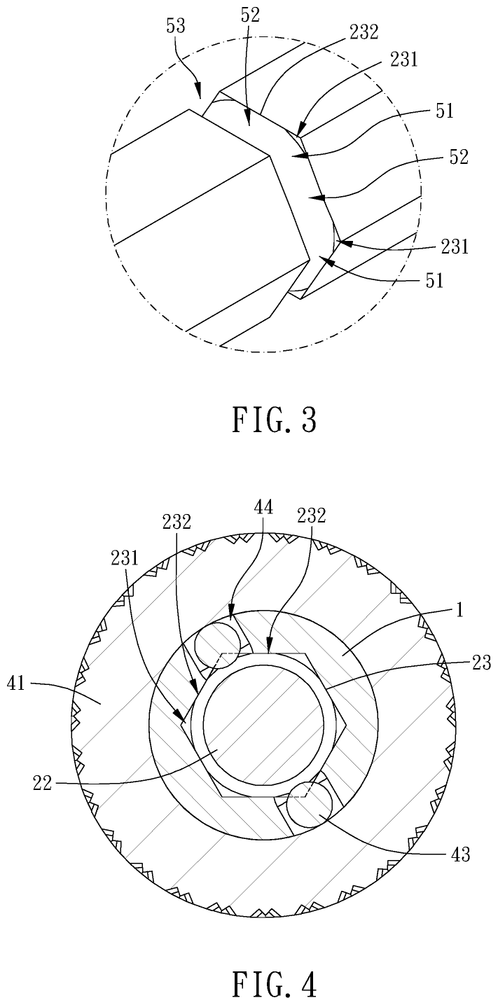

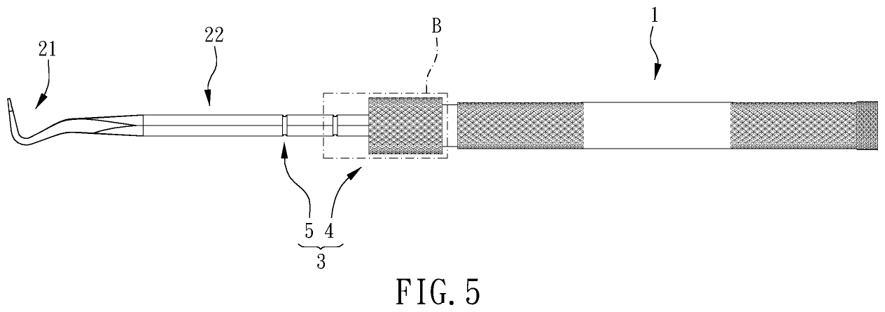

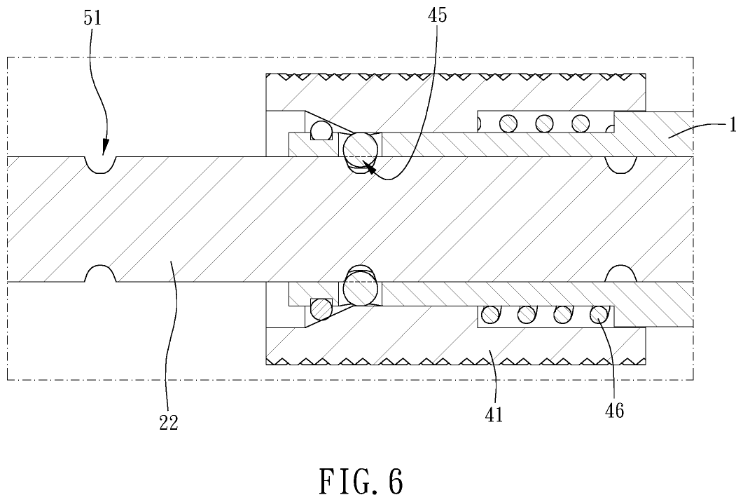

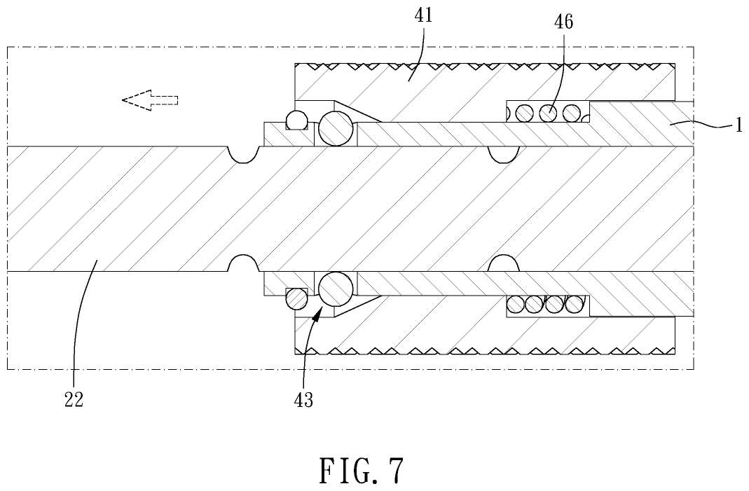

Please refer to FIGS. 1 to 7 for an exemplary embodiment of the present invention. A seal removal tool of the present invention includes a handle 1, a working rod 2 and a positioning mechanism 3.

The working rod 2 includes a working head 21 and a body portion 22 connected to each other, and the working head 21 is a curved plate member. An free end of the working head 21 remote from the body portion 22 has a thickness smaller than 1.5 mm, which is easy to be inserted into and between the seal (such as gasket, O-ring or the like) and elements so that it is effective to remove the seal. The body portion 22 has a non-circular cross-section, and the body portion 22 and the handle 1 are connected to each other by insertion. The body portion 22 which is non-circular ensures that the handle 1 and the working rod 2 are rotatable with each other. In this embodiment, the working head 21 is hook-shaped so that can drive the seal away from the assembled components through levering easily and can effectively remove the seal.

The positioning mechanism 3 includes at least one first positioning unit 4 and at least one second positioning unit 5 releasably connected to each other, the at least one first positioning unit 4 is disposed on the handle 1, and the at least one second positioning unit 5 is disposed on the body portion 22. The working rod 2 can be locked or released through the positioning mechanism 3. The user can replace the handle 1 or the working rod 2 of different sizes/styles according to various requirements, or the working rod 2 may be used alone, which can provide a variety of uses. In this embodiment, one of the first positioning unit 4 and the second positioning unit 5 includes at least one recess 51, the other of the first positioning unit 4 and the second positioning unit 5 includes at least one detent 45, and the first positioning unit 4 and the second positioning unit 5 are engaged with and positioned to each other.

Specifically, the handle 1 includes an insertion hole 11, the shape of the insertion hole 11 matches with the shape of the body portion 22, the body portion 22 is inserted in the insertion hole 11, the at least one first positioning unit includes only one first positioning unit 4, the first positioning unit 4 includes a slidable sleeve 41, at least one ball member 43 and at least one through hole 44, the at least one through hole 44 is disposed through the handle 1 and in communication with the insertion hole 11, and the at least one ball member 43 is movably received in the at least one through hole 44, the slidable sleeve 41 is disposed on the handle 1 and movable between. When the slidable sleeve 41 is located in the lock position, the slidable sleeve 41 urges the at least one ball member 43 to be partially protrusive out beyond the insertion hole 11 to serve as the at least one detent 45 to be engaged in the at least one recess 51 so that the working rod 2 is locked with the handle 1. When the slidable sleeve 41 is located in the release position, the at least one ball member 43 is retractable form the insertion hole 11 to be disengaged from the at least one recess 51 so that the working rod 2 is removable from the handle 1.

Specifically, the first positioning unit 4 further includes an elastic member 46, the elastic member 46 is disposed around the body portion 22, and the elastic member 46 is located between the body portion 22 and the slidable sleeve 41 so that the slidable sleeve 41 is remained to be located in the lock position normally, being highly safe. Preferably, an anti-slip structure 42 is disposed on an outer surface of the slidable sleeve 41, for stable grip and control; the handle 1 includes two anti-slip sections 12 arranged thereon, between the two anti-slip sections 12 is a smooth section 13, the two anti-slip sections 12 improve stable grip and control.

Preferably, the at least one recess includes a plurality of recesses 51, the plurality of recesses 51 are circumferentially arranged on the body portion 22, and the plurality of recesses 51 provides positioning means for the body portion 22. If the at least one detent includes a plurality of detents 45, the detent 45 may be engaged in any of the plurality of recesses 51, which is convenient for operation. Additionally, the plurality of the detents 45 and the plurality of recesses 51 engaged with each other in various positions so that it enhances the combination and stability of the working rod 2 and the handle 1 and it can evenly disperses the stress.

In this embodiment, the second positioning unit 5 further includes a plurality of channels 52 on the body portion 22, each of the plurality of channels 52 is disposed between two neighboring ones of the plurality of recesses 51, and the plurality of the channel 52 are in communication with the plurality of recesses 51 to form annular grooves 53; that is, the annular groove 53 serves as the second positioning unit 5. In a radial direction of the body portion 22 a distance from a bottom of each of the plurality of recesses 51 to the body portion 22 an axis of is equal to a distance from a bottom of each of the plurality of channels 52 to the axis of the body portion 22. When holding the working rod 2, the structure of the annular groove 53 can increase the contact area for stable grip. In addition, the shape of the annular groove 53 is also conducive to rapid processing production.

The cross-section of the body portion 22 is a regular polygon 23, the regular polygon 23 may be a regular hexagon, the regular polygon 23 includes a plurality of corners 231 and a plurality of sides 232, the plurality of recesses 51 are arranged to correspond to the plurality of the corner 231, respectively, so that in the axial direction of the body portion 22 the plurality of the detents 45 are engaged with and blocked by and the plurality of the corners 231. There is sufficient space from the outermost side of the corner 231 to the center of the circumscribed circle to accommodate the ball member 43 (the detent 45). When the slidable sleeve 41 is located in the lock position, the ball member 43 can be considerably overlapped with the corner 231, providing good locking effect.

Preferably, the at least one second positioning unit includes a plurality of second positioning units 5, the plurality of the second positioning unit 5 (the annular grooves 53) are arranged in interval in the axial direction of the body portion 22, and the working rod 2 is adjustably positioned to the handle 1, which allows adjustment of a length of the working rod 2 protrusive from the handle 1. In this embodiment, in the axial direction of the body portion 22, the plurality of annular grooves 53 are spaced in a fixed interval, which is easy to control the length of the body portion 22 protrusive from the handle 1. Preferably, in the axial direction of the body portion 22, a ratio of a dimension of the annular groove 53 to the fixed interval ranges from 0.08 to 0.10, which provides good structural strength.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A seal removal tool including:
a handle;
a working rod including a working head and a body portion connected to each other, the body portion having a non-circular cross-section, the body portion and the handle being connected to each other by insertion; and
a positioning mechanism including at least one first positioning unit and at least one second positioning unit releasably connected to each other, the at least one first positioning unit being disposed on the handle, the at least one second positioning unit being disposed on the body portion.

2. The seal removal tool of claim 1, wherein one of the first positioning unit and the second positioning unit includes at least one recess, the other of the first positioning unit and the second positioning unit includes at least one detent, and the first positioning unit and the second positioning unit are engaged with and positioned to each other.

3. The seal removal tool of claim 2, wherein the handle includes an insertion hole, the body portion is inserted in the insertion hole, the at least one first positioning unit includes only one first positioning unit, the only one first positioning unit includes a slidable sleeve, at least one ball member and at least one through hole, the at least one through hole is disposed through the handle and in communication with the insertion hole, the at least one ball member is movably received in the at least one through hole, the slidable sleeve is disposed on the handle and movable between a lock position and a release position, when the slidable sleeve is located in the lock position, the slidable sleeve urges the at least one ball member to be partially protrusive out beyond the insertion hole to serve as the at least one detent to be engaged in the at least one recess so that the working rod is locked with the handle, and when the slidable sleeve is located in the release position, the at least one ball member is retractable form the insertion hole to be disengaged from the at least one recess so that the working rod is removable from the handle.

4. The seal removal tool of claim 3, wherein the shape of the insertion hole matches with the shape of the body portion.

5. The seal removal tool of claim 2, wherein the at least one recess includes a plurality of recesses, the plurality of recesses are circumferentially arranged on the body portion, and the working rod is adjustably positioned to the handle.

6. The seal removal tool of claim 5, wherein each of the at least one second positioning unit further includes a plurality of channels on the body portion, each of the plurality of channels is disposed between two neighboring ones of the plurality of recesses, and the plurality of the channels are in communication with the plurality of recesses to form annular grooves.

7. The seal removal tool of claim 2, wherein the at least one second positioning unit includes a plurality of second positioning units, and the plurality of second positioning units are arranged in interval in an axial direction of the body portion.

8. The seal removal tool of claim 1, wherein the working head is a curved plate member.

9. The seal removal tool of claim 3, wherein the cross-section of the body portion is a regular polygon, the regular polygon includes a plurality of corners and a plurality of sides, and the at least one recess is arranged to correspond to at least one the plurality of corners so that in an axial direction of the body portion the at least one detent is engaged with and blocked by at least one the plurality of corners.

10. The seal removal tool of claim 4, wherein the at least one recess includes a plurality of recesses, the plurality of recesses are circumferentially arranged on the body portion, and the working rod is adjustably positioned to the handle; each of the at least one second positioning unit further includes a plurality of channels on the body portion, each of the plurality of channels is disposed between two neighboring ones of the plurality of recesses, and the plurality of the channels are in communication with the plurality of recesses to an annular groove; the at least one second positioning unit includes a plurality of second positioning units, and the plurality of second positioning units are arranged in interval in an axial direction of the body portion; the working head is a curved plate member; the cross-section of the body portion is a regular polygon, the regular polygon includes a plurality of corners and a plurality of sides, and the at least one recess is arranged to correspond to at least one the plurality of corners so that in an axial direction of the body portion the at least one detent is engaged with and blocked by at least one the plurality of corners; in a radial direction of the body portion, a distance from a bottom of each of the plurality of recesses to an axis of the body portion is equal to a distance from a bottom of each of the plurality of channels to the axis of the body portion; the regular polygon is a regular hexagon; the first positioning unit further includes an elastic member, the elastic member is disposed around the body portion, and the elastic member is located between the body portion and the slidable sleeve; the handle includes two anti-slip sections arranged thereon, and between the two anti-slip sections is a smooth section; an anti-slip structure is disposed on an outer surface of the slidable sleeve; in the axial direction of the body portion, the annular grooves of the plurality of second positioning units are spaced in a fixed interval, and in the axial direction of the body portion a ratio of a dimension of the annular groove to the fixed interval ranges from 0.08 to 0.10; the working head is hook-shaped, and a free end of the working head remote from the body portion has a thickness smaller than 1.5 mm.
